(19) United States
(12) Patent Application Publication
(10) Pub. No.: US 2025/0112970 A1
(43) Pub. Date: Apr. 3, 2025

(54) DISTRIBUTION OF DATA PACKETS FOR CONTROLLING OF INDUSTRIAL DEVICES

(71) Applicant: TELEFONAKTIEBOLAGET LM ERICSSON (PUBL), Stockholm (SE)

(72) Inventors: Sándor RÁCZ, Cegléd (HU); Norbert REIDER, Tényö (HU); Peter DE BRUIN, Gammelstad (SE)

(21) Appl. No.: 18/729,718

(22) PCT Filed: Jan. 17, 2022
(86) PCT No.: PCT/SE2022/050045

§ 371 Date: Jul. 17, 2024

(51) Int. Cl. H04L 67/12; H04B 17/309; H04W 4/70; H04W 28/06

(52) U.S. Cl. CPC H04L 67/12; H04B 17/309; H04W 4/70; H04W 28/065

(57) ABSTRACT

Embodiments of the present disclosure provide a method for transmission of data for controlling a plurality of industrial devices in an industrial environment. The plurality of industrial devices being connected to a user equipment (UE). The method is performed by a network node in the wireless communication network. The method includes acquiring control messages intended for controlling the plurality of industrial devices, wherein each industrial device is associated with a device identifier. The method includes generating a data packet comprising the control messages, each control message being associated to a corresponding device identifier. The method further includes transmitting the data packet to the UE for distribution of the control messages to the plurality of industrial devices.

### TECHNICAL FIELD

The present disclosure relates to communication in an industrial environment. More particularly, it relates to methods, network node, user equipment, UE, and computer program products for distribution of data packets for controlling a plurality of industrial devices in the industrial environment.

### BACKGROUND

industrial automation is becoming increasingly popular due to rapid development in sensors, control system, and other manufacturing techniques. In industrial automation, various kinds of industrial devices (such as 6DOF robotic arms, collaborating robotic arms, Automated Guided Vehicles, AGVs, with omni-wheels, or other robotic devices) are used to automate various process in industries. For example, the industrial environment includes a plurality of industrial devices that receive control messages from a controller and perform an assigned task.

In case of a collaborating task, for example, when two robotic arms are holding an object, inconsistent movement of robotic arms can result in deviation from the synchronized movement and in this way e.g. tension in the object occurs. Precisions or synchronized movement of industrial devices requires synchronized control of involved actuators of the industrial devices. One of the challenge is that a partial loss of control messages or delayed difference among control messages sent to the industrial devices can result in performance degradation or failed operation. This challenge may become more critical when the control messages are sent to the industrial devices through the wireless communication network. Thus, the underlying challenge is the potential (relative) latency jitter that is the result of distributing control messages from a central (on-board) unit to a plurality of industrial devices over a wireless communication network. For example, in case of AGV, inconsistent speed of omni-wheels can result in skidding one or more wheels or directional error in movement.

Therefore, today's (cellular) latency performance in combination with the (on-board) distribution of control messages causes more latency variations (jitter) than acceptable by industrial requirements.

### SUMMARY

Consequently, there is a need for an improved method and arrangement for improving latency variation that alleviates at least some of the above cited problems.

It is therefore an object of the present disclosure to provide a method, a network node, a UE and a computer program product for transmission of data packets for controlling a plurality of industrial devices to mitigate, alleviate, or eliminate all or at least some of the above-discussed drawbacks of presently known solutions.

This and other objects are achieved by means of a method, a network node, a UE and a computer program product as defined in the appended claims. The term exemplary is in the present context to be understood as serving as an instance, example or illustration.

According to a first aspect of the present disclosure, a method for transmission of data for controlling a plurality of industrial devices in an industrial environment is disclosed. The plurality of industrial devices is connected to a user equipment, UE. The method is performed by a network node in the wireless communication network. The method comprises acquiring control messages intended for controlling the plurality of industrial devices. Each industrial device is associated with a device identifier. The method comprises generating a data packet comprising the control messages, each control message is associated to a corresponding device identifier. The method further comprises transmitting the data packet to the UE for distribution of the control messages to the plurality of industrial devices.

In some embodiments, the step of generating the data packet comprising the control messages comprises obtaining the plurality of device identifiers. The method further comprises multiplexing the control messages and the plurality of device identifiers into the data packet.

According to a second aspect of the present disclosure, a method for transmission of data for controlling a plurality of industrial devices in an industrial environment is provided. Each of the industrial device is equipped with a user equipment, UE, the method is performed by a network node, in a wireless communication network. The method comprises acquiring control messages intended for controlling the plurality of industrial devices. The method comprises generating data packets comprising the control messages and corresponding device identifiers associated with the plurality of industrial devices. The method further comprises transmitting the data packets to each UE based on an estimated radio link quality for each UE.

In some embodiments, the step of transmitting the data packets to each UE based on an estimated radio link quality for each UE comprises estimating the radio link quality in the wireless communication network for each UE. The method comprises identifying at least one UE having weakest radio link quality and transmitting the data packet to the at least one UE. The method further comprises determining whether the transmission of the data packet to the at least one UE is successful and upon the determination that the transmission of the data packet to the at least one UE is successful, transmitting the data packets to each UE.

In some embodiments, the method further comprises upon the determination that the transmission of the data packet to the at least one UE is unsuccessful, discarding the data packets.

In some embodiments, the method further comprises determining whether the transmission of the data packets is successful for each UE based on a received feedback from each UE. Further, the method comprises upon the determination that the transmission of the data packets is successful for each UE, transmitting a signal indicating a distribution command to each UE for distributing the data packets to the plurality of industrial devices.

In some embodiments, the method further comprises upon the determination that the transmission of the data packets is unsuccessful for at least one UE, transmitting a signal indicating a discard command to each UE for discarding the data packets.

According to a third aspect of the present disclosure, a method for reception of data for controlling a plurality of industrial devices in an industrial environment is provided. The plurality of industrial devices is connected to a user equipment, UE. The method is performed by the UE, in a wireless communication network. The method comprising receiving a data packet from a network node, the data packet comprising control messages and a plurality of device identifiers, wherein each industrial device is associated with a device identifier. The method further comprises transmitting the data packet to the plurality of industrial devices.

In some embodiments, the step of transmitting the data packet to the plurality of industrial devices comprises demultiplexing the control messages and the plurality of device identifiers from the data packet. The method comprises identifying each control message intended to each of the industrial device based on the device identifier. The method further comprises transmitting the control message to each of the industrial device.

According to a fourth aspect of the present disclosure, a method for reception of data for controlling a plurality of industrial devices in an industrial environment is provided. The plurality of industrial devices is connected to a user equipment, UE. The method is performed by the UE, in a wireless communication network. The method comprising receiving data packets from a network node, the data packets comprising control messages intended to control the plurality of industrial devices. The method further comprises determining whether the data packets for each of the industrial device are received at the UE. The method further comprises transmitting the data packets to the plurality of industrial devices.

In some embodiments, the step of determining whether the data packets for each of the industrial device are received at the UE s comprises registering an arrival time associated with each data packet and determining an elapsed time interval for each of the data packet based on the registered arrival time. The method further comprises determining that the elapsed time interval for each of the data packet has reached a pre-configured threshold value and discarding at least one data packet for which the elapsed time interval has reached the pre-configured threshold value.

According to a fifth aspect of the present disclosure, an apparatus of a network node configured to operate in a wireless communication network for transmission of data for controlling a plurality of industrial devices in an industrial environment is provided. The plurality of industrial devices is connected to a user equipment, UE. The apparatus comprising controlling circuitry configured to cause acquisition of control messages intended for controlling the plurality of industrial devices, wherein each industrial device is associated with a device identifier. The controller is configured to cause generation of a data packet comprising the control messages, each control message being associated to a corresponding device identifier. Further, the controller is configured to cause transmission of the data packet to the UE for distribution of the control messages to the plurality of industrial devices.

A sixth aspect is a network node comprising the apparatus of the fifth aspect.

According to a seventh aspect of the present disclosure, an apparatus for a network node configured to operate in a wireless communication network for transmission of data for controlling a plurality of industrial devices in an industrial environment is provided. Each of the industrial device is equipped with a user equipment, UE. The controlling circuitry is configured to cause acquisition of control messages intended for controlling the plurality of industrial devices. Further, the controlling circuitry is configured to cause generation of data packets comprising the control messages and corresponding device identifiers associated with the plurality of industrial devices. The controlling circuitry is further configured to cause transmission of the data packets to each UE based on an estimated radio link quality for each UE.

An eighth aspect is network node comprising the apparatus of the seventh aspect.

According to a ninth aspect of the present disclosure, a user equipment, UE, configured to operate in a wireless communication network for transmission of data for controlling a plurality of industrial devices in an industrial environment is provided. The plurality of industrial devices is connected to a user equipment, UE. The controlling circuitry is configured to cause reception of a data packet from a network node, the data packet comprising control messages and a plurality of device identifiers. Each industrial device is associated with a device identifier. Further, the controlling circuitry is configured to cause transmission of the data packet to the plurality of industrial devices.

According to a tenth aspect of the present disclosure, a user equipment, UE, configured to operate in a wireless communication network for transmission of data for controlling a plurality of industrial devices in an industrial environment is provided. The plurality of industrial devices is connected to a user equipment, UE. The controlling circuitry is configured to cause reception of data packets from a network node, the data packets comprising control messages intended to control the plurality of industrial devices. Further, the controlling circuitry is configured to cause determination of whether the data packets for each of the industrial device are received at the UE and transmission of the data packet to the plurality of industrial devices.

According to a eleventh aspect of the present disclosure, there is provided a computer program product comprising a non-transitory computer readable medium, having thereon a computer program comprising program instructions. The computer program is loadable into a data processing unit and configured to cause execution of the method according to any of the first to fourth aspects when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for minimizing the variation of latency in distribution of data among different industrial devices.

An advantage of some embodiments is that improved approaches are provided for controlling industrial devices in a coordinated manner.

An advantage of some embodiments is that the data packets are distributed with minimum or no latency variation in distribution of data among different industrial devices.

An advantage of some embodiments is that the performance degradation or failed operations in the factory environment can be mitigated.

An advantage of some embodiments is that the potential relative latency jitter that is the result from distributing information from a central (on-board) unit to a number of entities (industrial devices) over an internal network is mitigated.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B discloses an example of an industrial environment according to some embodiments;

FIG. 2 is a flowchart illustrating example method steps according to some embodiments;

FIG. 3 is an example illustration for transmission of a data packet to the industrial devices according to some embodiments;

FIG. 4 is a flowchart illustrating example method steps according to some embodiments;

FIG. 5 is a flowchart illustrating example method steps according to some embodiments;

FIG. 6 is a flowchart illustrating example method steps according to some embodiments;

FIG. 7 is a schematic block diagram illustrating an example apparatus according to some embodiments;

FIG. 8 is a schematic block diagram illustrating an example apparatus according to some embodiments; and

FIG. 9 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

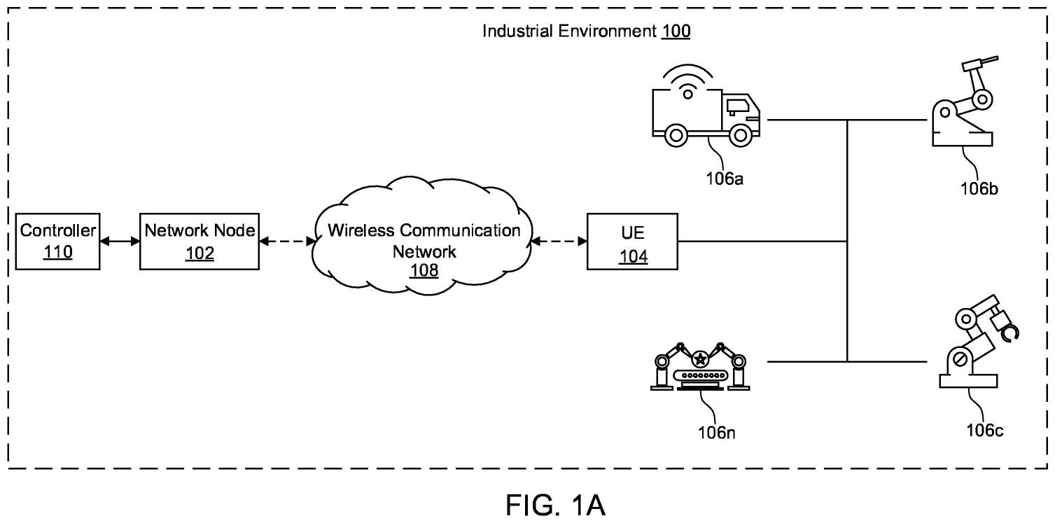

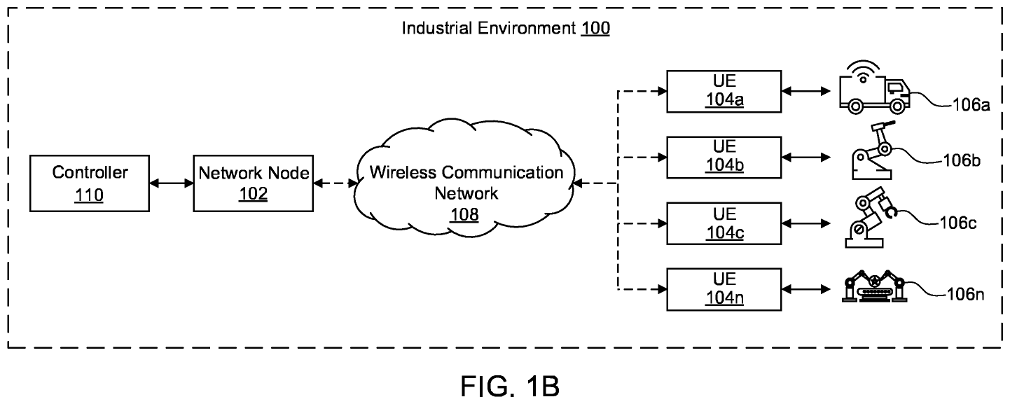

FIG. 1A discloses an industrial environment 100. Some of the examples of the industry environment 100 may include a factory, a manufacturing unit, guided robotic environment, or the like. The industrial environment 100 comprises a network node 102, a user equipment, UE, 104, and a plurality of industrial devices 106a, 106b, 106c and so on to 106n. The network node 102 communicates with the UE 104 through a wireless communication network 108 for controlling the plurality of industrial devices 106a-106n. For example, the UE 104 is configured to receive data packets from the network node 102 through the wireless communication network 108. For example, the network node 102 may be a radio access network comprising a plurality of base stations or evolved node base stations (not shown) or the internet using one or more suitable communication protocols for transmitting the data packets to the UE 104. The industrial environment 100 may further comprise a controller 110 configured to generate control messages according to an input from a user. Examples of the industrial devices 106a-106n may include a 6DOF robotic arm, collaborating robotic arms, Automated Guided Vehicles, AGVs, with omni-wheels, or other robotic devices.

The network node 102 is configured to acquire one or more control messages intended to control the industrial devices 106a-106n from the controller 110. The control messages may comprise a set of commands intended for the industrial devices 106a-106n. For example, each industrial device 106a-106n comprises one or more actuators (e.g. servos, arms or the like, not shown in FIG. 1) for performing assigned tasks. The set of commands may be defined by an application installed in the network node 102 or may be acquired from an external controller 110. The set of commands instruct the industrial devices 106a-106n how to perform the task. For example, the set of commands comprise a trajectory path to be followed by the industrial device 106a-106n. Further, the network node 102 transmits the control messages to the UE 104 through the wireless communication network 108. The UE 104 is configured to receive the control messages from the network node 102. The UE 104 further transmits the received control messages to the industrial devices 106a-106n. The industrial devices 106a-106n perform the allocated tasks according to the control messages. It should be noted that the industrial environment 100 is not limited to above-mentioned components, other components can also be present in the industrial environment 100 other than the component shown in the FIG. 1A.

In some examples, the network node 102 and/or the UE 104 may be a wireless device that is stationary or mobile and may also be referred to as a remote station, a mobile station, an application, a user equipment, a mobile equipment, a terminal, a remote terminal, an access terminal, a station, etc. The wireless device may be a cellular phone, a personal digital assistant (PDA), a wireless modem, a wireless communication device, a handheld device, a subscriber unit, a laptop computer, etc.

In one implementation, the industrial devices 106a-106n are connected with a single UE 104, as illustrated in FIG. 1A. In another implementation, each industrial device 106a-106n is equipped with a UE 104a-104n, as illustrated in FIG. 1B.

In case of collaborating task, when two or more industrial devices 106a-106n are intended to perform a task, all the target industrial devices 106a-106n need to perform in synchronized manner. For example, the target industrial devices 106a-106n must be performed in synchronized manner with precision. The challenge in this kind of collaborative task is that a partial loss of the control messages or delay difference among the control messages delivered to different industrial devices 106a-106n can result performance degradation or failed operation of the collaborative task. This challenge may become more critical when the control messages is sent to the industrial devices 106a-106n through the wireless communication network 108.

Therefore, according to some embodiments of the present disclosure, the network node 102 implements a method for efficiently transmitting the data packets for controlling the industrial devices 106a-106n in the industrial environment 100. Furthermore, the UE 104 implements a method for receiving the data packets for controlling the industrial devices 106a-106n in the industrial environment 100.

According to some embodiments of the present disclosure, in case of the first implementation where each industrial device 106a-106n is connected with a single UE 104, as shown in FIG. 1A, the network node 102 acquires control messages intended for controlling the plurality of industrial devices 106a-106n. For example, the control messages includes one or more commands intended for controlling the industrial devices 106a-106n. Further, each industrial device 106a-106n is associated with a device identifier. The device identifier is used to identify the industrial device. Examples of the device identifier may comprise an address of the industrial device, an identification number of the industrial device, a location of the industrial device, a type of the industrial device, or the like.

Further, the network node 102 generates the data packet comprising the control messages, each control message being associated to a corresponding device identifier. For example, the network node 102 obtains a plurality of device identifiers and multiplexes the device identifiers and the control messages into the single data packet. Further, the network node 102 transmits the data packet to the UE 104 for distribution of the control messages to the plurality of industrial devices 106a-106n.

According to some embodiments of the present disclosure, in case of the second implementation, where each industrial device 106a-106n is equipped with UE 104a-104n as shown in FIG. 1B, the network node 102 acquires control messages intended for controlling the plurality of industrial devices 106a-106n. For example, the control messages includes a set of commands intended for controlling the industrial devices 106a-106n.

Further, the network node 102 generates data packets comprising the control messages and corresponding device identifiers associated with the plurality of industrial devices. For example, multiple data packets are generated to include the control messages. Further, the network node 102 estimates a radio link quality in the wireless communication network 108 for each UE 104a-104n to identify at least one UE having weakest radio link quality. The network node 102 further transmits the data packets to the identified at least one UE. When the transmission of the data packet to the at least one UE is successful, the network node 102 transmits the data packets to each UE 104a-104n. Various embodiments for efficient transmission of data packets to the industrial device 106a-106n are explained in conjunction with figures in the later parts of the description.

Above explained methods for transmitting the data packets to the industrial devices 106a-106n is able to deliver the command messages to all the target industrial devices 106a-106n at a same point of time. Thus, the latency variation among control messages due to wireless communication network is mitigated. The collaborative task is performed by the plurality of industrial devices 106a-106n in synchronized manner. Therefore, the performance degradation or failed operation of the industrial devices 106a-106n can be improved.

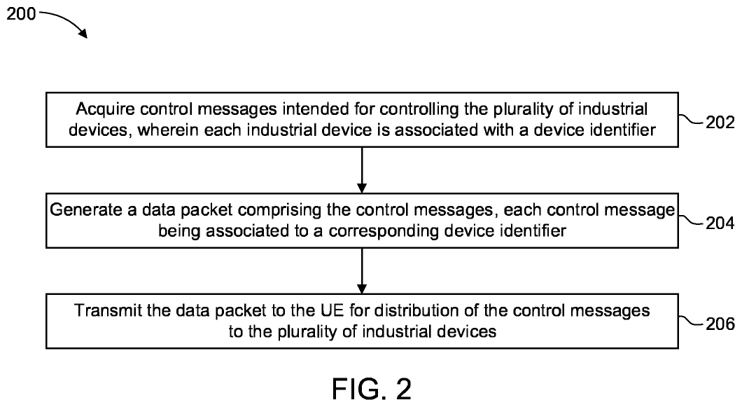

FIG. 2 is a flowchart illustrating example method steps of a method 200 performed by the network node in the wireless communication network for transmission of data for controlling a plurality of industrial devices. The plurality of industrial devices are connected to a user equipment, UE, in an industrial environment.

At step 202, the method 200 comprises acquiring control messages intended for controlling the plurality of industrial devices. Each industrial device is associated with a device identifier. For example, the control messages may include a set of commands that instruct the industrial device to move in a particular trajectory such that a specific task is performed. In some embodiments, the control messages may be generated by a controller (e.g. robotic controller) according to a user preference. The controller receives an input from the user and generates the control messages according to the input. The control further transmits the control messages to the network node for delivery of the control messages to the industrial devices. In other embodiments, the network node may include a processor that generates the control messages and the network node obtains the control messages from the processor.

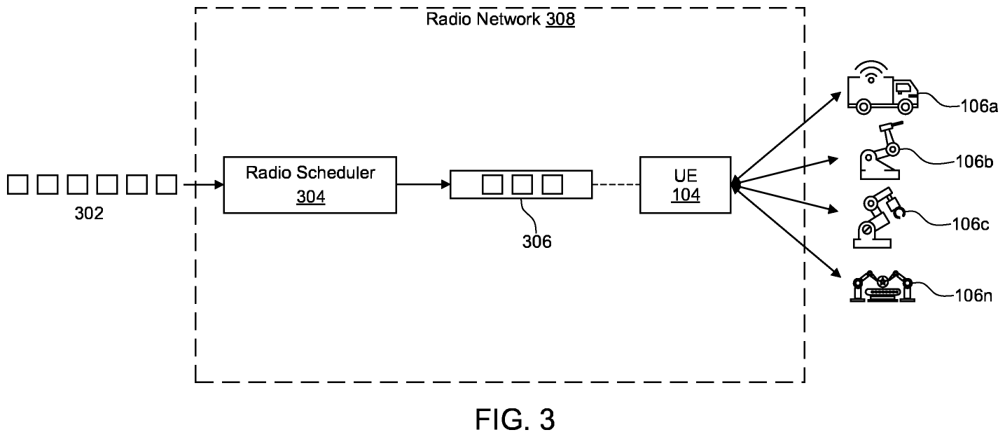

At step 204, the method 200 comprises generating a data packet comprising the control messages, each control message is associated to a corresponding device identifier. The network node generates a data packet to be transmitted to the UE. The network node obtains a plurality of device identifiers. Each industrial device is associated with a device identifier. For example, the industrial device may be identified based on the device identifier. Further, the network node multiplexes the control messages and the plurality of device identifier into the data packet. Thus, a single data packet is generated to include the control messages intended for the plurality of industrial device as further elaborated in FIG. 3.

FIG. 3 is an example illustration for transmission of data packet to the industrial devices. As depicted in FIG. 3, a radio scheduler 304 equipped in the network node receives internet protocol, IP, packets 302 from the controller. The IP packets 302 comprises the control messages intended for transmission to the plurality of industrial devices 106a-106n. The radio scheduler 304 extracts the control messages from the IP packets. The radio scheduler 304 further multiplexes the control messages with the plurality of device identifiers to generate the data packet 306. For example, the radio scheduler 304 generates a radio frame from the control messages. Example of the data packet may include a User Datagram Protocol, UDP, payload with a UDP header. If the control messages for each industrial device cannot be multiplexed into a single radio frame, then the data packets are transmitted using multiple radio frames. However, the transmission mechanism handles the multiple radio frames as a single virtual radio frame. Thus, a single data packet 306 is generated including the control messages for each industrial device 106a-106n.

At step 206 of FIG. 2, the method 200 comprises transmitting the data packet to the UE for distribution of the control messages to the plurality of industrial devices. The network node transmits the data packets to the UE through the wireless communication network using network resources. As shown in FIG. 3, the radio scheduler 304 transmits the data packet (e.g. UDP payload) to the UE 104 through the radio network 308. Further, the UE 104 transmits the data packet to the plurality of industrial devices 106a-106n.

The network node transmits a single data packet including the control messages to the UE. Thus, all control messages are received to UE at a same point of time. Thus, the latency variation in reception of the data packet among the industrial devices may be mitigated in case of a collaborative task to be performed by the industrial devices.

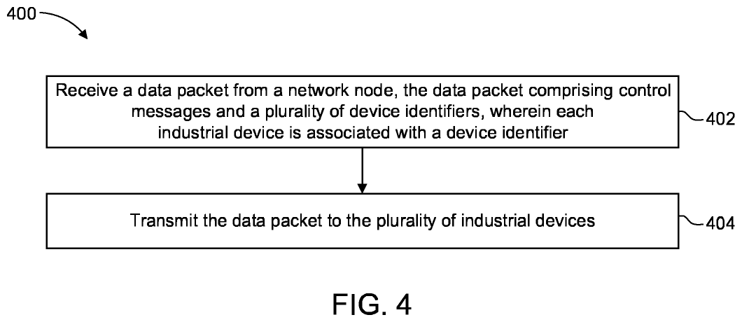

FIG. 4 is a flowchart illustrating example method steps of a method 400 performed by the UE in the wireless communication network for reception of data for controlling a plurality of industrial devices. The plurality of industrial devices is connected to the UE in the industrial environment. A single UE serves each industrial device as depicted in FIG. 1A.

At step 402, the method 400 comprises receiving a data packet from a network node. The data packet comprises control messages and a plurality of device identifiers. Each industrial device is associated with the device identifier. For example, the UE acts as a central entity which receives control messages for each industrial device and transmits the control messages to the plurality of industrial devices for performing the assigned task. As depicted in FIG. 3, the UE 104 receives the data packet (e.g. UDP payload) 306 through the radio network 308.

At step 404, the method 400 comprises transmitting the data packet to the plurality of industrial devices. The UE transmits the received data packet to the plurality of industrial devices for the execution of the assigned task. The data packet is transmitted to the plurality of industrial devices through a wired connection having negligible latency.

In some embodiments, the UE transmits the data packet directly to each industrial device. Each industrial device extracts the corresponding control messages based on the device identifiers. For example, each industrial device receives the data packet including the control messages and the plurality of device identifiers from the UE. Further, each industrial device extracts the corresponding control messages according to the device identifier. The industrial device perform the task based on the control messages. The UE transmits the data packet to each industrial device at a same point of time. Thus, the latency variation between the industrial devices may be mitigated in case of collaborative task to be performed by the industrial devices.

In another embodiment, the UE demultiplexes the control messages and the plurality of device identifiers from the data packet. For example, the UE extracts the control messages and the plurality of device identifiers from the data packet by demultiplexing the data packet. The UE identifies each control message intended to each of the plurality of industrial devices based on the device identifier. For example, the UE analyzes the device identifier associated with each industrial device and extracts the control messages appended with the device identifier. In some embodiment, the UE may equipped with a gateway having a gateway function. The gateway function extracts and distributes control messages for each industrial device based on the device identifier. The UE further transmits the control messages to the corresponding industrial device. The industrial devices perform the task based on the control messages. The UE transmits the control messages to each industrial device at a same point of time. Thus, the latency variation between the industrial devices may be mitigated in case of collaborative task to be performed by the industrial devices.

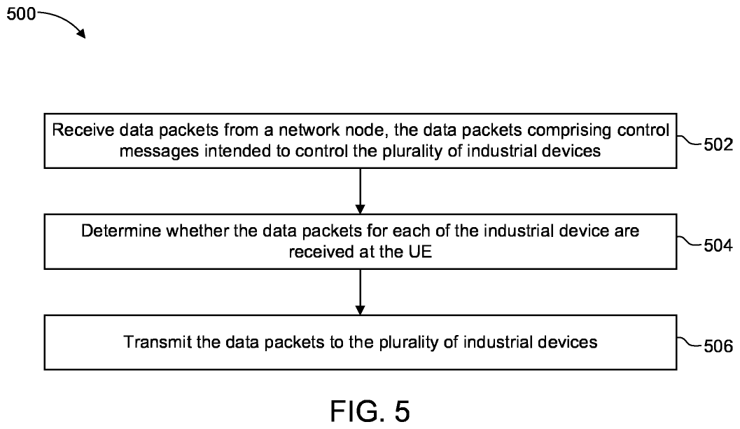

FIG. 5 is a flowchart illustrating example method steps of a method 500 performed by the UE in the wireless communication network for reception of data for controlling a plurality of industrial devices, the plurality of industrial devices are connected to the UE in the industrial environment.

At step 502, the method 500 comprises receiving data packets from a network node, the data packets comprising control messages intended to control the plurality of industrial devices. For example, the UE receives the data packets comprising the control messages through the wireless communication network. Further, the UE buffers the received data packets in a gateway or a storage unit (not shown in Drawings) equipped in the UE.

When a new data packet is arrived for a specific industrial device, the UE determines whether data packet for the specific industrial device is already present at the gateway. If the data packet for the industrial device is already present at the gateway, the UE discards the previous data packet from the gateway.

The UE registers an arrival time associated with each data packet. For example, the UE obtains the time instant at which the data packet arrives at the gateway. The UE determines an elapsed time interval for each of the data packet based on the registered arrival time. The UE further determines that the elapsed time interval for each of the data packet has reached a pre-configured threshold value and discards at least one data packet for which the elapsed time interval has reached the pre-configured threshold value. For example, the UE initiates a counter when each data packet arrives at the gateway. When the counter reaches the pre-configured threshold value for a specific data packet, the UE discards that data packet.

At step 504, the method 500 comprises determining whether the data packets for each of the industrial device are received at the UE. The UE analyzes the gateway to determine whether the data packets for each industrial device are received at the gateway. Thus, the UE buffers the data packets till the control messages for each industrial device is received.

At step 506, the method 500 comprises transmitting the data packets to the plurality of industrial devices. The UE transmits the received data packet to the plurality of industrial devices for the execution of the assigned task. The data packet is transmitted to the plurality of industrial devices through a wired connection having negligible latency delay. The UE transmits the data packet to each industrial device at a same point of time when the data packet for each industrial device has received on the gateway. Thus, the latency variation between the industrial devices may be mitigated in case of collaborative task to be performed by the industrial devices.

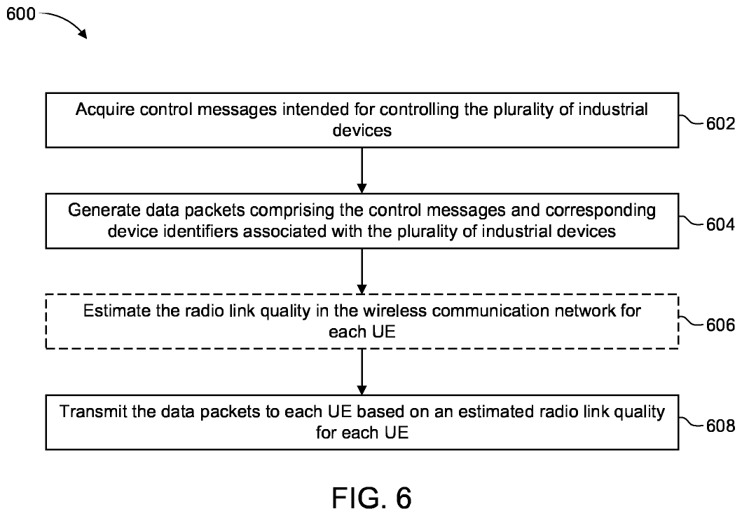

FIG. 6 is a flowchart illustrating example method steps of a method 600 performed by the network node in the wireless communication network for transmission of data for controlling a plurality of industrial devices, each of the industrial device is equipped with the UE, in the industrial environment.

At step 602, the method 600 comprises acquiring control messages intended for controlling the plurality of industrial devices. The network node acquires the control messages from the controller. The controller comprises an application that generates the control messages according to the input received from the user. The control messages comprise the set of commands for controlling the plurality of industrial devices. In case of collaborative task to be performed by two or more industrial devices, the control messages for two or more industrial devices are generated by the controller. The network node receives the control messages from the controller through a wired connection.

At step 604, the method 600 comprises generating data packets comprising the control messages and corresponding device identifiers associated with the plurality of industrial devices. The network node generates data packets to be transmitted to each UE equipped in the plurality of industrial devices. The network node generates separate data packet for each control message intended for controlling the plurality of industrial devices. For example, the network node identifies the control messages for each industrial device and generate different data packets including the control messages.

At step 608, the method 600 comprises transmitting the data packets to each UE based on an estimated radio link quality for each UE. The network node estimates the radio link quality between the network node and each UE as depicted in optional step 606 of FIG. 6. At step 606, the method 600 comprises estimating the radio link quality in the wireless communication network for each UE. For example, the network node obtains at least one parameter associated with the wireless link between the network node and each UE. Further, the network node analyses the at least one parameter and estimates the radio link quality between the network node and each UE based on the at least one parameter.

The network node identifies at least one UE having weakest radio link quality. The network node estimates a probability of successful transmission for each UE based on the radio link quality. For example, the network node analyses the radio link quality for each UE and determines the probability of successful transmission for each UE (e.g. a chance that the transmitted data packet is successfully received at the UE). According to the probability of successful transmission, the network node identifies at least one UE having least probability of successful transmission. Further, the network node transmits the data packet to the identified at least one UE having weakest radio quality. For example, the network node transmits the data packet to the at least one UE having least probability of successful transmission.

The network node determines whether the transmission of the data packet to the at least one UE is successful. The network node tracks the data packet sent to the at least one UE and decide whether the transmission is successful or not. Upon the determination that the transmission of the data packet to the at least one UE is successful, the network node transmits the data packets to each UE.

Further, when the network node determines that the transmission of the data packet to the at least one UE is unsuccessful, the network node discards the data packets. For example, upon tracking of the data packet sent to at least one UE the network node determines that the transmission of the data packet to the at least one UE is unsuccessful, then the network node discards the data packets. Thus, if the UE having weakest radio link quality is able to receive the data packet from the network node then remaining UEs with stronger radio link quality can also receive the data packets.

In some embodiments, each UE receives the data packets intended for controlling the plurality of industrial devices from the network node. The UE buffers the received data packets in a storage unit. Further, the UE transmits a feedback upon the reception of the data packets. The feedback indicates that the data packet is successfully received at the UE. In some embodiments, the UE determines whether an elapsed time interval associated with the data packet at the UE exceeds a pre-determined time limit based on the arrival time of the data packet at the UE. Upon the determination that the elapsed time interval for at least one data packet exceeds the pre-determined time limit, the UE discards the at least one data packet.

The network node receives the feedback from each UE based on the transmission of the data packets to each UE. Further, the network node determines whether the transmission of the data packets is successful for each UE based on the received feedback. For example, if the network node receives the feedback from the UE after transmitting the data packet to the UE, the network node determines that the data packet is successful transmitted to the UE. Upon the determination that the transmission of the data packets is successful for each UE, the network node transmits a signal indicating a distribution command to each UE. The distribution command instructs each UE to transmit the data packets to the plurality of industrial devices. Each UE transmits the data packets to the plurality of industrial devices based on the distribution command. Thus, each industrial device receives the control messages at a same point of time. Each industrial device performs the collaborative task at the same point of time. Thus, the latency variation between the industrial devices may be mitigated in case of collaborative task to be performed by the industrial devices.

Upon the determination that the transmission of the data packets is unsuccessful for each UE, the network node transmits a signal indicating a discard command to each UE. The distribution command instructs each UE to discard the data packets. Each UE discards the data packets based on the distribution command.

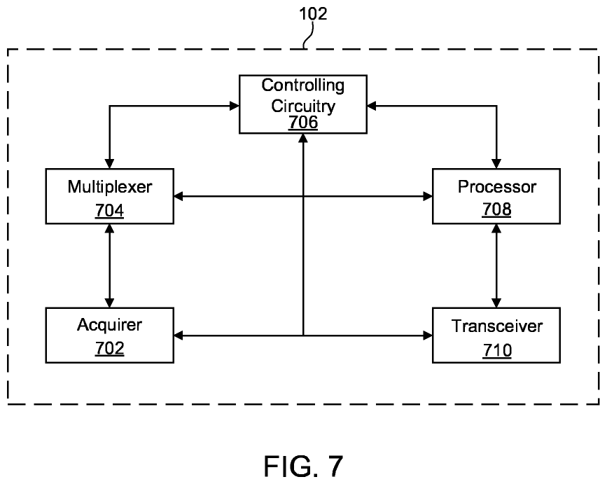

FIG. 7 is an example schematic diagram showing an apparatus 102. The apparatus 102 may e.g. be comprised in a network node. The apparatus 102 is capable of transmitting the data packets in the wireless communication network and may be configured to cause execution of the method 200 for transmission of data for controlling a plurality of industrial devices, the plurality of industrial devices are connected to a user equipment, UE, in an industrial environment.

According to at least some embodiments of the present invention, the apparatus 102 in the FIG. 7 comprises one or more modules. These modules may e.g. be an acquirer 702, a multiplexer 704, a controlling circuitry 706, a processor 708, and a transceiver 710. The controlling circuitry 706, may in some embodiments be adapted to control the above mentioned modules.

The acquirer 702, the multiplexer 704, the processor 708, and the transceiver 710 as well as the controlling circuitry 706, may be operatively connected to each other.

Optionally, the transceiver 710 may be adapted to transmit the connection request message to the content delivery server, acquire the control messages, transmit the data packets to the UE, and receive the feedback from the UE.

As described above, the various ways of transmitting the data packets to UE to deliver the control message to each of the plurality of industrial devices, a few of which have been mentioned above in connection to the explanation of FIG. 2.

The controlling circuitry 706 may be adapted to control the steps as executed by the network node 102. For example, the controlling circuitry 706 may be adapted to generate one or more data packets comprising a plurality of device identifiers and the control messages. Thus, the controlling circuitry 706 may be adapted to deliver the control messages to the plurality of industrial devices (as described above in conjunction with the method 200 and FIG. 2).

In addition, the transceiver 710 is also adapted to transmit the connection request message to the content delivery server, acquire the control messages, transmit the data packets to the UE, and receive the feedback from the UE.

Further, the processor 708 is adapted to perform the method 200.

Furthermore, the multiplexer 704 is adapted to multiplex the control messages and the plurality of device identifiers into the data packet.

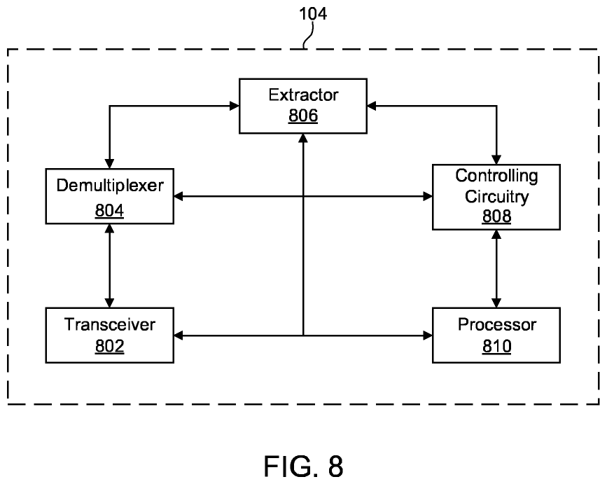

FIG. 8 is an example schematic diagram showing an apparatus 104. The apparatus 104 may e.g. be comprised in a UE. The apparatus 104 is capable of receiving the data packet from the network node, the data packet comprising control messages and a plurality of device identifiers, wherein each industrial device is associated with a device identifier. The apparatus 104 further capable of transmitting the data packet to the plurality of industrial devices.

According to at least some embodiments of the present invention, the apparatus 104 in FIG. 8 comprises one or more modules. These modules may e.g. be a transceiver 802, a demultiplexer 804, an extractor 806, a controlling circuitry 808, and a processor 810. The controlling circuitry 808, may in some embodiments be adapted to control the above mentioned modules.

The transceiver 802, the demultiplexer 804, the extractor 806, and the processor 810 as well as the controlling circuitry 808, may be operatively connected to each other.

Optionally, the transceiver 802 may be adapted to receive the data packets from the network node, transmit the data packets to the plurality of industrial devices and transmit the feedback to the network node.

The controlling circuitry 808 may be adapted to control the steps as executed by the UE 104. For example, the controlling circuitry 808 may be adapted to deliver the control messages to each industrial device based on the device identifier (as described above in conjunction with the method 400 and FIG. 4).

In addition, the transceiver 802 is also receive the data packet from the network node and transmit the data packets to the corresponding industrial identifier.

Further, the demultiplexer 802 is adapted to demultiplex the control messages and the plurality of device identifiers from the data packet.

Furthermore, the extractor 804 is adapted to extract the control messages from the data packets based on the plurality of device identifiers.

Further, the transceiver 802 may be adapted to receive the data packets from the network node, transmit the data packets to the plurality of industrial devices and transmit the feedback to the network node.

The processor 806 is adapted register an arrival time associated with each data packet, determine an elapsed time interval for each of the data packet based on the registered arrival time, determine that the elapsed time interval for each of the data packet has reached a pre-configured threshold value, and discard at least one data packet for which the elapsed time interval has reached the pre-configured threshold value.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

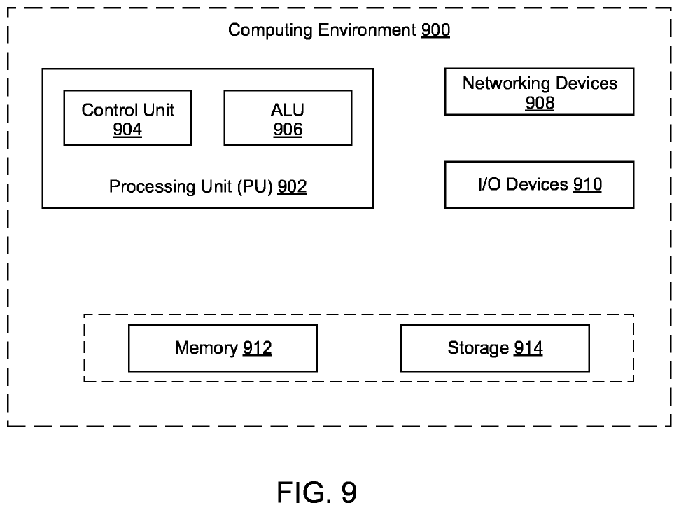

FIG. 9 illustrates an example computing environment 900 implementing the method, the network node and the UE as described in FIGS. 2-6. As depicted in FIG. 9, the computing environment 900 comprises at least one processing unit 902 that is equipped with a control unit 904 and an Arithmetic Logic Unit, ALU 906, a plurality of networking devices 908 and a plurality Input output, I/O devices 910, a memory 912, and a storage 914. The processing unit 902 may be responsible for implementing the method described in FIGS. 2-6. For example, the processing unit 902 may in some embodiments be equivalent to the processor of the network node and the UE described above in conjunction with the FIGS. 1-8. The processing unit 902 is capable of executing software instructions stored in memory 912. The processing unit 902 receives commands from the control unit 904 in order to perform its processing. Further, any logical and arithmetic operations involved in the execution of the instructions are computed with the help of the ALU 906.

The computer program is loadable into the processing unit 902, which may, for example, be comprised in an electronic apparatus (such as a UE or a network node). When loaded into the processing unit 902, the computer program may be stored in the memory 912 associated with or comprised in the processing unit 902. According to some embodiments, the computer program may, when loaded into and run by the processing unit 902, cause execution of method steps according to, for example, any of the methods illustrated in FIGS. 1-8 or otherwise described herein.

The overall computing environment 900 may be composed of multiple homogeneous and/or heterogeneous cores, multiple CPUs of different kinds, special media and other accelerators. Further, the plurality of processing unit 902 may be located on a single chip or over multiple chips.

The algorithm comprising of instructions and codes required for the implementation are stored in either the memory 912 or the storage 914 or both. At the time of execution, the instructions may be fetched from the corresponding memory 912 and/or storage 914, and executed by the processing unit 902.

In case of any hardware implementations various networking devices 908 or external I/O devices 910 may be connected to the computing environment to support the implementation through the networking devices 808 and the I/O devices 910.

The embodiments disclosed herein can be implemented through at least one software program running on at least one hardware device and performing network management functions to control the elements. The elements shown in FIG. 9 include blocks which can be at least one of a hardware device, or a combination of hardware device and software module.

1. (canceled)

2. (canceled)

3. A method for transmission of data for controlling a plurality of industrial devices in an industrial environment, each of the industrial device being equipped with a user equipment (UE), the method being performed by a network node in a wireless communication network, the method comprising:
acquiring control messages intended for controlling the plurality of industrial devices;
generating data packets comprising the control messages and corresponding device identifiers associated with the plurality of industrial devices; and
transmitting the data packets to each UE based on an estimated radio link quality for each UE.

4. The method according to claim 3, wherein the step of transmitting the data packets to each UE based on an estimated radio link quality for each UE comprises:
estimating the radio link quality in the wireless communication network for each UE;
identifying at least one UE having weakest radio link quality;
transmitting the data packet to the at least one UE;
determining whether the transmission of the data packet to the at least one UE is successful; and
upon the determination that the transmission of the data packet to the at least one UE is successful, transmitting the data packets to each UE.

5. The method according to claim 4, further comprising:
upon the determination that the transmission of the data packet to the at least one UE is unsuccessful, discarding the data packets.

6. The method according to claim 3, further comprising:
determining whether the transmission of the data packets is successful for each UE based on a received feedback from each UE; and
upon the determination that the transmission of the data packets is successful for each UE, transmitting a signal indicating a distribution command to each UE for distributing the data packets to the plurality of industrial devices.

7. The method according to claim 6, further comprising:
upon the determination that the transmission of the data packets is unsuccessful for at least one UE, transmitting a signal indicating a discard command to each UE for discarding the data packets.

8. (canceled)

9. (canceled)

10. A method for reception of data for controlling a plurality of industrial devices in an industrial environment, the plurality of industrial devices being connected to a user equipment (UE), the method being performed by the UE in a wireless communication network, the method comprising:
receiving data packets from a network node, the data packets comprising control messages intended to control the plurality of industrial devices;
determining whether the data packets for each of the industrial device are received at the UE; and
transmitting the data packets to the plurality of industrial devices.

11. The method according to claim 10, wherein the step of determining whether the data packets for each of the industrial device are received at the UE comprises:
registering an arrival time associated with each data packet;
determining an elapsed time interval for each of the data packet based on the registered arrival time;
determining that the elapsed time interval for each of the data packet has reached a pre-configured threshold value; and
discarding at least one data packet for which the elapsed time interval has reached the pre-configured threshold value.

12-14. (canceled)

15. An apparatus of a network node configured to operate in a wireless communication network for transmission of data for controlling a plurality of industrial devices in an industrial environment, each of the industrial device being equipped with a user equipment (UE), the apparatus comprising controlling circuitry configured to cause:
acquisition of control messages intended for controlling the plurality of industrial devices;
generation of data packets comprising the control messages and corresponding device identifiers associated with the plurality of industrial devices; and
transmission of the data packets to each UE based on an estimated radio link quality for each UE.

16. The apparatus according to claim 15, wherein the controlling circuitry is configured to cause the step of transmitting the data packets to each UE based on an estimated radio link quality for each UE by causing:
estimation of the radio link quality in the wireless communication network for each UE;
identification of at least one UE having weakest radio link quality;
transmission of the data packet to the at least one UE;
determination of whether the transmission of the data packet to the at least one UE is successful; and
upon the determination that the transmission of the data packet to the at least one UE is successful, transmission of the data packets to each UE.

17. The apparatus according to claim 16, wherein the controlling circuitry is further configured to cause:
upon the determination that the transmission of the data packet to the at least one UE is unsuccessful, discard of the data packets.

18. The apparatus according to claim 15, wherein the controlling circuitry is further configured to cause:
determining whether the transmission of the data packets is successful for each UE based on a received feedback from each UE; and
upon the determination that the transmission of the data packets is successful for each UE, transmission of a signal indicating a distribution command to each UE for distributing the data packets to the plurality of industrial devices.

19. The apparatus according to claim 18, wherein the controlling circuitry is further configured to cause:
upon the determination that the transmission of the data packets is unsuccessful for at least one UE, transmission of a signal indicating a discard command to each UE for discarding the data packets.

20-25. (canceled)
